(19) United States
(12) Patent Application Publication
(10) Pub. No.: US 2020/0294108 A1
(43) Pub. Date: Sep. 17, 2020

(54) RECOMMENDATION ENGINE FOR MARKETING ENHANCEMENT

(71) Applicant: Shopify Inc., Ottawa (CA)

(72) Inventors: Michael Leander Perry, Oakland, CA (US); Harshit Talasila, Mississauga (CA); Kam Chon Chio, Etobicoke (CA); Eric Wichman, York (CA)

(21) Appl. No.: 16/351,670

(22) Filed: Mar. 13, 2019

(51) Int. Cl. G06Q 30/06; G06N 20/00; G06Q 30/02

(52) U.S. Cl. CPC G06Q 30/0631; G06Q 30/0201; G06N 20/00

(57) ABSTRACT

A computer-implemented methods and systems including a processor-based recommendation engine retrieving merchant commerce data from a data facility, wherein the merchant commerce data is associated with a plurality of online stores and comprising a plurality of merchant actions; identifying a first online store currently in a first merchant development phase; identifying a merchant opportunity for the first online store based on the plurality of merchant actions to determine at least one merchant action with a positive return on investment value; generating at least one merchant recommendation for the first online store associated with the determined at least one merchant action; and communicating the at least one merchant recommendation to a client device of the first online store.

### FIELD

The present disclosure relates generally to methods for enhancing marketing effectiveness, and more particularly to a recommendation decision engine that provides merchant recommendations based on the processing of e-commerce data from a plurality of online stores.

### BACKGROUND

On-line merchants need to understand how to promote and market their product in order to ensure sales and market share. However, specific data-based knowledge is lacking, and merchants often have to resort to generic business management techniques or learn from merchants that have successfully grown their business. However, even if a merchant could have access to such data, continuously sifting through such large data sets would be impractical if not impossible.

Therefore, there is a need for systems and methods to model marketing effectiveness based on large e-commerce data in order to provide merchants with recommendations for marketing and/or increasing sales of their products and services.

### SUMMARY

In an aspect, a computer-implemented method may include retrieving, by a processor-based recommendation engine, merchant commerce data from a data facility, wherein the merchant commerce data is associated with a plurality of online stores; identifying a subset of the plurality of online stores that have transitioned from a first merchant development phase to a second merchant development phase; identifying a first online store currently in the first merchant development phase; determining, by the processor-based recommendation engine and utilizing a model generated using machine learning, a plurality of merchant actions taken by the subset of the plurality of online stores while in the first merchant development phase; identifying a merchant opportunity for the first online store based on the plurality of merchant actions to determine at least one merchant action with a positive return on investment value; generating at least one merchant recommendation for the first online store associated with the determined at least one merchant action; and communicating the at least one merchant recommendation to a client device of the first online store. In embodiments, the second merchant development phase may be determined to have a greater commerce success measure than the first merchant development phase. The first merchant development phase may be associated with an online store without customers, and the second merchant development phase is associated with an online store with customers. The second merchant development phase may be characterized by a statistically significant growth in customers over the first merchant development phase. The plurality of merchant actions may include an initiation of at least one paid advertisement. The at least one paid advertisement may be applied to an e-commerce channel. The at least one merchant recommendation may be communicated through a home page of the first online store. The at least one merchant recommendation may be communicated through a commerce agent to the first online store. The at least one merchant recommendation may be communicated through an email to a merchant of the first online store.

In an aspect, a computer-implemented method may include retrieving, by a processor-based recommendation engine, merchant commerce data from a data facility, wherein the merchant commerce data is associated with a plurality of online stores and comprising a plurality of merchant actions; identifying a first online store currently in a first merchant development phase; identifying a merchant opportunity for the first online store based on the plurality of merchant actions to determine at least one merchant action with a positive return on investment value; generating at least one merchant recommendation for the first online store associated with the determined at least one merchant action; and communicating the at least one merchant recommendation to a client device of the first online store. In embodiments, the identifying the merchant opportunity may be executed by the processor-based recommendation engine utilizing a model generated using machine learning. Identifying a subset of the plurality of online stores may be provided that have transitioned from the first merchant development phase to a second merchant development phase, wherein the second merchant development phase is determined to have a greater commerce success measure than the first merchant development phase. Identifying a subset of the plurality of online stores may be provided that have transitioned from the first merchant development phase to a second merchant development phase, wherein first merchant development phase is associated with an online store without customers, and the second merchant development phase is associated with an online store with customers. Identifying a subset of the plurality of online stores may be provided that have transitioned from the first merchant development phase to a second merchant development phase, wherein second merchant development phase is characterized by a statistically significant growth in customers over the first merchant development phase. The plurality of merchant actions may include an initiation of at least one paid advertisement. The at least one paid advertisement may be applied to an e-commerce channel. The at least one merchant recommendation may be communicated through a home page of the first online store. The at least one merchant recommendation may be communicated through a commerce agent to the first online store. The at least one merchant recommendation may be communicated through an email to a merchant of the first online store.

In an aspect, a computer-implemented method may include retrieving, by a processor-based recommendation engine, merchant commerce data from a data facility, wherein the merchant commerce data is associated with a plurality of online stores and comprises merchant marketing activity data; identifying a subset of the plurality of online stores that have transitioned from a first merchant development phase to a second merchant development phase; identifying a first online store currently in the first merchant development phase; determining, by the processor-based recommendation engine and utilizing a model generated using machine learning, a plurality of merchant actions taken by the subset of the plurality of online stores while in the first merchant development phase, wherein the plurality of merchant actions is determined from evaluation of the merchant marketing activity data; identifying a merchant opportunity for the first online store based on the plurality of merchant actions; and communicating the merchant opportunity to a client device of the first online store. In embodiments, the second merchant development phase may be determined to have a greater commerce success measure than the first merchant development phase. The first merchant development phase may be associated with an online store without customers, and the second merchant development phase is associated with an online store with customers. The second merchant development phase may be characterized by a statistically significant growth in customers over the first merchant development phase. The plurality of merchant actions may include an initiation of at least one paid advertisement. The at least one paid advertisement may be applied to an e-commerce channel. The merchant opportunity may be communicated through a home page of the first online store. The merchant opportunity may be communicated through a commerce agent to the first online store. The merchant opportunity may be communicated through an email to a merchant of the first online store.

In an aspect, a system may include a processor-based recommendation engine configured to store a set of instructions that, when executed, cause the processor-based recommendation engine to: retrieve merchant commerce data from a data facility, wherein the merchant commerce data is associated with a plurality of online stores; identify a subset of the plurality of online stores that have transitioned from a first merchant development phase to a second merchant development phase; identify a first online store currently in the first merchant development phase; determine, by the processor-based recommendation engine and utilizing a model generated using machine learning, a plurality of merchant actions taken by the subset of the plurality of online stores while in the first merchant development phase; identify a merchant opportunity for the first online store based on the plurality of merchant actions to determine at least one merchant action with a positive return on investment value; generate at least one merchant recommendation for the first online store associated with the determined at least one merchant action; and communicate the at least one merchant recommendation to a client device of the first online store. In embodiments, the second merchant development phase may be determined to have a greater commerce success measure than the first merchant development phase. The first merchant development phase may be associated with an online store without customers, and the second merchant development phase is associated with an online store with customers. The second merchant development phase may be characterized by a statistically significant growth in customers over the first merchant development phase. The plurality of merchant actions may include an initiation of at least one paid advertisement. The at least one paid advertisement may be applied to an e-commerce channel. The at least one merchant recommendation may be communicated through a home page of the first online store. The at least one merchant recommendation may be communicated through a commerce agent to the first online store. The at least one merchant recommendation may be communicated through an email to a merchant of the first online store.

In an aspect, a system may include a processor-based recommendation engine configured to store a set of instructions that, when executed, cause the processor-based recommendation engine to: retrieve merchant commerce data from a data facility, wherein the merchant commerce data is associated with a plurality of online stores and comprising a plurality of merchant actions; identify a first online store currently in a first merchant development phase; identify a merchant opportunity for the first online store based on the plurality of merchant actions to determine at least one merchant action with a positive return on investment value; generate at least one merchant recommendation for the first online store associated with the determined at least one merchant action; and communicate the at least one merchant recommendation to a client device of the first online store. In embodiments, the identifying the merchant opportunity may be executed by the processor-based recommendation engine utilizing a model generated using machine learning. Identifying a subset of the plurality of online stores may be provided that have transitioned from the first merchant development phase to a second merchant development phase, wherein the second merchant development phase is determined to have a greater commerce success measure than the first merchant development phase. Identifying a subset of the plurality of online stores may be provided that have transitioned from the first merchant development phase to a second merchant development phase, wherein first merchant development phase is associated with an online store without customers, and the second merchant development phase is associated with an online store with customers. Identifying a subset of the plurality of online stores may be provided that have transitioned from the first merchant development phase to a second merchant development phase, wherein second merchant development phase is characterized by a statistically significant growth in customers over the first merchant development phase. The plurality of merchant actions may include an initiation of at least one paid advertisement. The at least one paid advertisement may be applied to an e-commerce channel. The at least one merchant recommendation may be communicated through a home page of the first online store. The at least one merchant recommendation may be communicated through a commerce agent to the first online store. The at least one merchant recommendation may be communicated through an email to a merchant of the first online store.

In an aspect, a system may include a processor-based recommendation engine configured to store a set of instructions that, when executed, cause the processor-based recommendation engine to: retrieve merchant commerce data from a data facility, wherein the merchant commerce data is associated with a plurality of online stores and comprises merchant marketing activity data; identify a subset of the plurality of online stores that have transitioned from a first merchant development phase to a second merchant development phase; identify a first online store currently in the first merchant development phase; determine, by the processor-based recommendation engine and utilizing a model generated using machine learning, a plurality of merchant actions taken by the subset of the plurality of online stores while in the first merchant development phase, wherein the plurality of merchant actions is determined from evaluation of the merchant marketing activity data; identify a merchant opportunity for the first online store based on the plurality of merchant actions; and communicate the merchant opportunity to a client device of the first online store. In embodiments, the second merchant development phase may be determined to have a greater commerce success measure than the first merchant development phase. The first merchant development phase may be associated with an online store without customers, and the second merchant development phase is associated with an online store with customers. The second merchant development phase may be characterized by a statistically significant growth in customers over the first merchant development phase. The plurality of merchant actions may include an initiation of at least one paid advertisement. The at least one paid advertisement may be applied to an e-commerce channel. The merchant opportunity may be communicated through a home page of the first online store. The merchant opportunity may be communicated through a commerce agent to the first online store. The merchant opportunity may be communicated through an email to a merchant of the first online store.

### BRIEF DESCRIPTION OF THE FIGURES

FIG. 1 depicts an embodiment of an e-commerce platform.

FIG. 2 depicts an embodiment of a home page of an administrator.

FIG. 3 depicts an embodiment block diagram of a recommendation engine.

FIG. 4 depicts an embodiment functional diagram for recommendation engine processing based on a business development stage.

FIG. 5 depicts an embodiment merchant user interface.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

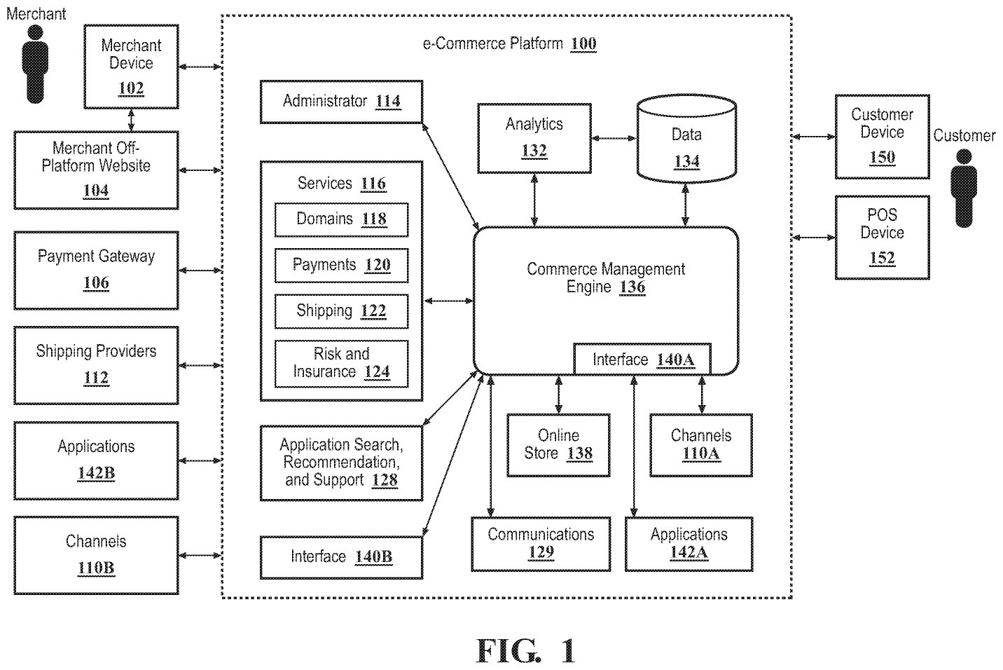

With reference to FIG. 1, an embodiment e-commerce platform 100 is depicted for providing merchant products and services to customers. While the disclosure throughout contemplates using the apparatus, system, and process disclosed to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In embodiments, elements of the e-commerce platform 100 may be implemented to operate on various platforms and operating systems, such as i0S, Android, on the web, and the like (e.g., the administrator 114 being implemented in multiple instances for a given online store for iOS, Android, and for the web, each with similar functionality).

In embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

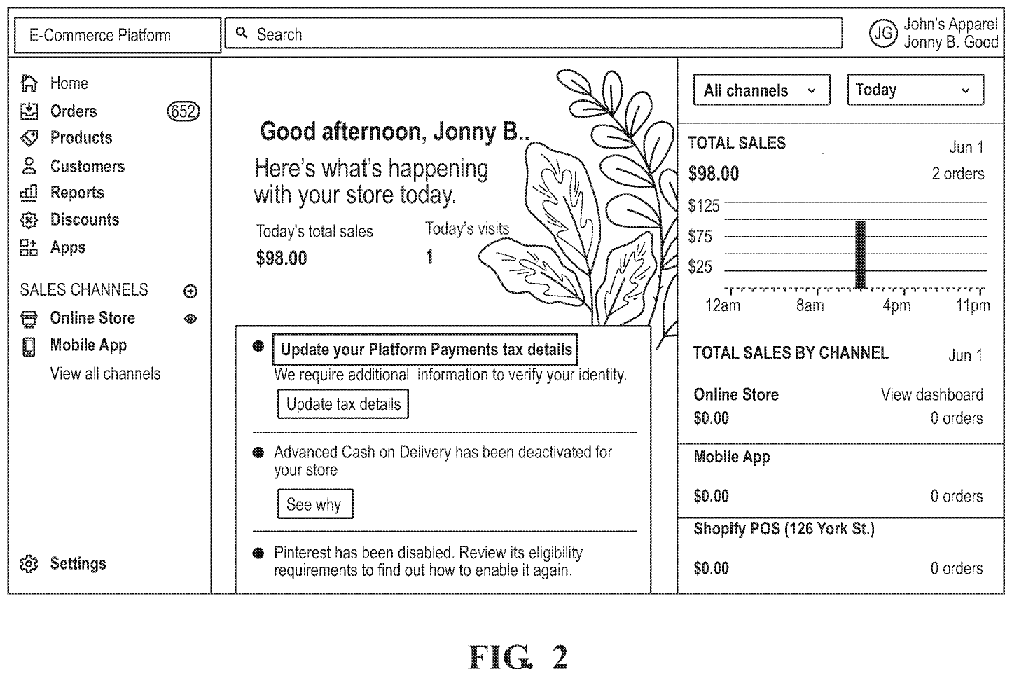

FIG. 2 depicts a non-limiting embodiment for a home page of an administrator 114, which may show information about daily tasks, a store's recent activity, and the next steps a merchant can take to build their business. In embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In embodiments, an application 142A may be provided by the same party providing the platform 100 or by a different party. In embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In embodiments, rather than violating the isolation principle, it may be preferred to move these components out of the commerce management engine 136 and into their own infrastructure within the e-commerce platform 100.

In embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions / API), and the like. Merchants may be enabled to discover and install applications 142A-B through application search, recommendations, and support 128. In embodiments, core products, core extension points, applications, and the administrator 114 may be developed to work together. For instance, application extension points may be built inside the administrator 114 so that core features may be extended by way of applications, which may deliver functionality to a merchant through the extension.

In embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In embodiments, partners, application developers, internal applications facilities, and the like, may be provided with a software development kit (SDK), such as through creating a frame within the administrator 114 that sandboxes an application interface. In embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In embodiments, update events may be queued and processed asynchronously from a state change that triggered them, which may produce an update event notification that is not distributed in real-time.

In embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In embodiments, the payment gateway 106 may accept international payment, such as integrating with leading international credit card processors. The card server environment may include a card server application, card sink, hosted fields, and the like. This environment may act as the secure gatekeeper of the sensitive credit card information. In embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In embodiments, the e-commerce platform 100 may enable merchants to keep track of changes to the contract of sales over time, such as implemented through a sales model component (e.g., an append-only date-based ledger that records sale-related events that happened to an item).

In embodiments, the e-commerce platform 100 may utilize e-commerce data stored in a data facility 134 to utilize analytics 132 to generate recommendations to a merchant. The e-commerce platform 100 may support a great number of independently administered online stores and process a large volume of e-commerce transactional data, such as sales data, product data, customer audience data, marketing data, merchandising data, advertisement conversion data, advertisement budget information, interactions between merchants and customers, interactions between merchants and service providers, social media interaction data, marketing campaign information, and the like. The e-commerce transactional data may be processed through analytics 132 to produce recommendations to merchants, such as regarding consumer trends, marketing and sales insights, improving sales, evaluation of customer behaviors, marketing and sales modeling, and the like.

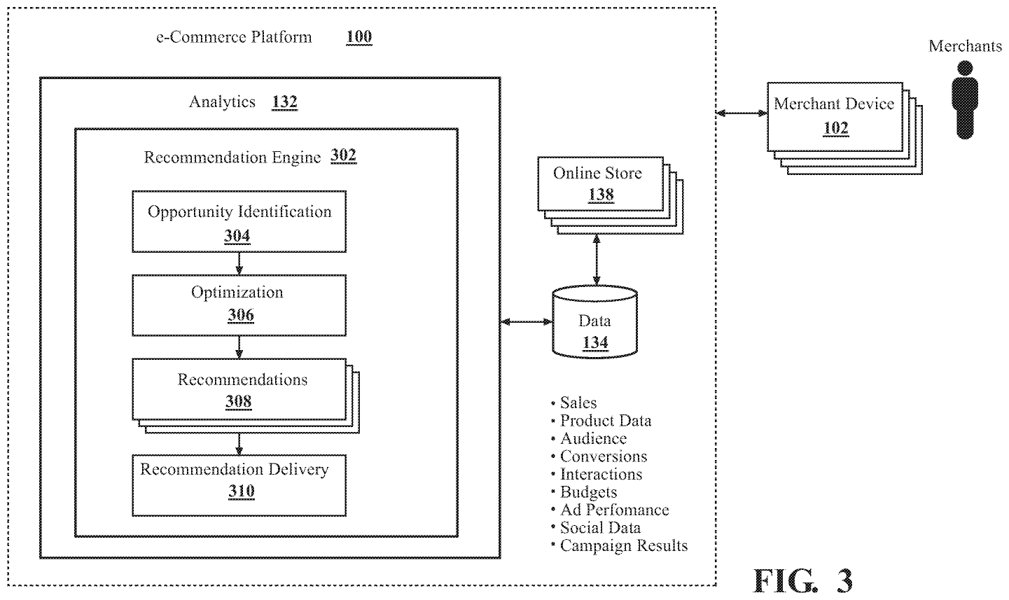

Referring to FIG. 3, e-commerce platform analytics 132 may process transactional data stored in the data facility 134 to generate recommendations to merchants, such as where analytics 132 utilize the large e-commerce data sets stored in the data facility 134 to determine specific recommendations to a merchant related to the next best step the merchant could take to achieve a business development goal, such as finding an audience (e.g. spending on audience building through social media), making a first sale (e.g., a first sale through a first product-cost offering to a new audience), making multiple sales (e.g., where the merchant migrates from audience building to product-based advertising), optimizing the merchant's spending (e.g., optimizing spending across an additional audience building effort executed through social media or product marketing through a search engine based marketing tool), and the like.

In embodiments, analytics 132 may include a recommendation engine 302 for generating recommendations to merchants related to identifying next best marketing opportunities, such as where the recommendation decision engine 302 utilizes machine learning to model marketing success states as a function of business development stages for a plurality of online stores. The process through which the recommendation engine 302 generates recommendations may include first identifying an opportunity 304 for an online store, such as through the model of success states relating to cross-platform business success of other merchants across the e-commerce platform 100 and for various options related to a stage of business development for the merchant(s). For example, the recommendation engine 302 may identify that the merchant's online store is in an early development phase with no customers and is in an opportunity state ready to promote its products with a budget. The recommendation engine 302 may then optimize the opportunity 306, such as identifying specific actions and options that the merchant could take based on the actions that other similar online stores have taken under similar circumstances, in similar business stages, with similar products. Optimization may produce options for the merchant based on the merchant's current business and marketing state, as well as on actions of similar online stores. Many different actions or options may exist, including actions/options in or external to the merchant's on-line store. Online store actions/options may generally include a change in certain settings such as activation of an automated email setting for abandoned carts/checkouts or activation of a discount setting for orders over a threshold, activation of a “free shipping” setting for orders over a threshold, and the like. Examples of actions external to an online store may include activation of a paid advertisement campaign on one or more external platforms (e.g. Google, Facebook). For example, the specific action may include a paid advertising placement for establishing an interested audience for products that are to be offered along with specifics as to where, when, and how to make such advertisements (e.g., how to introduce the product into a social media venue), where the specific action is to be taken based on actions taken by other similar online merchants (as derived from cross-platform commerce data). From the optimization step, the recommendation engine 302 may generate a plurality of next-best-action recommendations 308 from which to choose one or more recommendations 308 for delivery 310 to the merchant (e.g., sending one or more recommendations now and queuing further recommendations for subsequent delivery). The recommendation engine 302 may then determine the optimal delivery configuration for the recommendation(s) 308, such as when to deliver the recommendation 308 and through what medium or channel (e.g., the merchant home page, through the administrator, through email, through a channel, and the like). In embodiments, the decision of how to deliver the recommendation may be based on merchant preferences, merchant behavior, and the like, where the ‘merchant’ may be the merchant receiving the recommendations, similar merchants (e.g., merchants associated with transactional data stored in the data facility 134), or a combination of the two.

In embodiments, opportunity identification 304 may include online store specific marketing tactics that have the potential to improve a sales parameter (e.g., gross sales, sales for specific products, or sales over a period of time), an audience parameter (e.g., number of audience visits, number of audience members, better audience targeting, or higher relevant audience), a customer relationship parameter (e.g., repeat customers or loyalty of customers), a brand awareness parameter (e.g., social media presence or recommendations), and the like. Opportunities may be identified as an opportunity for the merchant to initiate a marketing action, such as based on aggregated cross-platform data stored in the data facility 134 (e.g., data collected from online merchants across the e-commerce platform 100 that are similar to the target merchant). For example, the recommendation engine may reveal data that indicates a trending product, which may present an opportunity for the merchant to advertise that product at this particular moment. The recommendation engine may reveal data that indicates a reduced conversion rate for an audience, which may present an opportunity for the merchant to retarget that audience. The recommendation engine may identify the merchant as having a diverse product offering with respect to a merchant's business development stage (e.g., a relatively new merchant may have a few products that are selling and others that are new), which may present an opportunity to advertise the different products through different channels (e.g., a search engine such as Google vs. social network such as Facebook). The recommendation engine may identify a surge in popularity of the merchant's online store, which may present the opportunity to broadly advertise the entire online store's product offering.

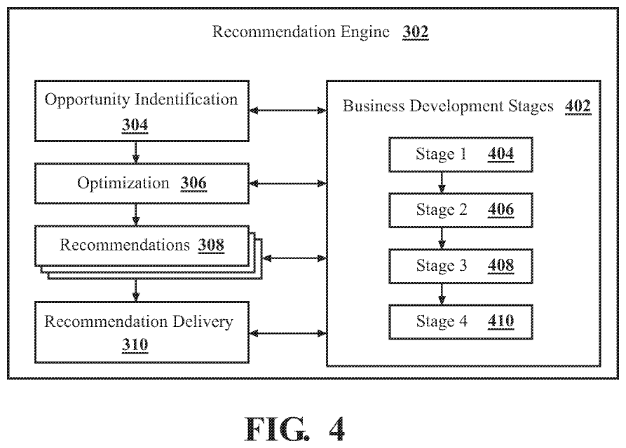

Referring to FIG. 4, in embodiments opportunity identification 304 may be based on the merchant's business development stage 402, such as the merchant being in a new merchant stage, in a mature merchant stage, in a mature merchant stage with a new product/product line, and the like. In embodiments, opportunities may be unique for merchants in a first stage of business development 404, such as were the merchant is still finding an audience for the online store or the product/product line. For instance, the recommendation engine 302 may identify an opportunity for a merchant in this first stage of business development to take time to spend budget resources on audience building through social media (e.g., on Facebook), target an older audience through a search engine (e.g., Bing), and the like. As the merchant transitions to a second stage of business development 406, such as when the merchant is ready to make a first sale, the recommendation engine 302 may identify an opportunity for a merchant to make a first sale through a first product-cost offering to a new audience (e.g., the audience the merchant built in the first stage). As the merchant transitions to a third stage of business development 408, such as when the merchant is making multiple sales, the recommendation engine 302 may identify an opportunity for a merchant to migrate from audience building to product-based advertising, such as shifting advertising dollars from an audience-based channel (e.g., Facebook) to a more product-based channel (e.g., Google).

Once a merchant achieves a fourth stage of business development 410, such as where the merchant has a steady stream of sales, store visits, recommendations, and the like, the recommendation engine 302 may begin identifying opportunities for a merchant to optimize a merchant's spend for marketing resources, such as optimizing the spend across additional audience building through audience-based channels vs. product marketing through product-based channels. The recommendation engine 302 may identify opportunities for optimizing return on investment (ROI) with respect to audience value, such as to high value audience targets. For instance, a merchant may not mind investing to get a new customer now if they will make that investment back in multiples over time, such as through acquiring a customer that has a high probability of returning as a customer (e.g., when a product purchase invests the customer in a technology platform, such as when a customer switches cell phone technologies, or in a service plan or subscription, such as a cell service family plan). Knowing that a merchant will retain a customer helps to justify a higher upfront advertisement investment. Thus, the recommendation engine 302 may identify opportunities associated with high audience value.

In an alternate embodiment, opportunity identification 304 may be based on the merchant's business development stage 402 with respect to traffic as a shop state of the merchant, such as a merchant site not being ready to open yet (e.g., no product listed or payment facility), a site being ready but receiving no traffic, a site with traffic but no sales, a site with traffic and has sales, a site with traffic and has repeat sales, and the like. For instance, in a first stage of business development 404 a merchant may experience no traffic (e.g., the merchant site is new, and so the site has not yet received any traffic). At this shop state the merchant marketing goal may be to have the merchant site discovered and measure the success of being discovered such as through site visit metrics. To gain success, recommendations may be provided to the merchant to utilize shopping sites (e.g., Google shopping) to gain product visibility, or social media sites (e.g., Facebook) to gain an interest in the product or product idea; reach out to target audiences such as through paid searches or internet-based audiences; through search engine optimization; social media marketing, content marketing, or email marketing; and the like. In a second stage of business development 406 a merchant may experience traffic to the merchant site but with no sales (e.g., the site has attracted attention, but no one is buying products yet). At this shop state the merchant marketing goal may be to engage the customers that are visiting the site and measure success such as through metrics that measure repeated visits resulting in a sale. To gain success, recommendations may be provided to the merchant for marketing products through social media (e.g., Facebook carousel advertisements, targeting custom audiences, or retargeting audiences), shopping media (e.g., Google shopping through remarketing); retargeting audiences or emailing audiences; through on-site optimizations (e.g., adjusting cart emails, targeting guest checkout, or offering free shipping); increased social media marketing; increased organic content marketing (e.g., getting customers to come to the merchant naturally over time, rather than through paid links or boosted posts); and the like. In a third stage of business development 408 a merchant may experience traffic and have sales (e.g., people are visiting the site and making purchases rather than just visiting and browsing the product offerings). At this shop state the merchant marketing goal may be to increase sales and measure success through metrics such as through measuring a return on ad spending. To gain success, recommendations may be provided to the merchant for initiating a shopping campaign (e.g., a shopping campaign through Google); target look-alike audiences, custom audiences, or through email contacts; optimizing onsite merchandizing, adjusting site automations (e.g., adjusting checkout emails), or providing for discounts (e.g., through discount codes); and the like. In a fourth stage of business development 410 a merchant may experience traffic, sales, and repeat customers (e.g., customers coming back to purchase additional products). At this shop state the merchant marketing goal may be to build loyalty and measure success such as through returning customer rate metrics, lifetime customer value (e.g., total spend or orders), and the like. To gain success, recommendations may be provided to the merchant through email or other contacts with past or established customers; offering exclusive product promotions, targeted discounts, cross-selling, or cross merchandizing; and the like.

In embodiments, determining a business development stage 402 for a merchant may help determine if a merchant is ready for specific recommendations associated with different marketing channel segments or events, such as through social media, referrals, searches, conversations, product display, email, newsletter, notifications, posts, messages, transactions, affiliates, paid advertising, following up products in an ‘abandoned cart’, retargeting campaigns, follow-ups with customers, loyalty programs, providing links (e.g., product links, product related articles, or blogs), and the like.

In embodiments, the recommendation engine 302 may identify opportunities based on transactional data stored in the data facility 134, such as including data types and sources for identifying an opportunity. For instance, transactional data may include marketing campaign results from merchants (including the target merchant, similar or other merchants across the platform, or in combination), such as including the marketing activity that is or has taken place, and the results of that activity. The recommendation engine 302 may identify opportunities based on results received directly through a marketing events API or a marketing engagement API from the target merchant online store or from across online stores on the e-commerce platform 100. Historical campaign data may be aggregated for campaigns from merchants, such as from different stages of enterprise and/or product development/marketing (e.g., including history for the target merchant, history from other merchants, a mixture of both the target merchant and other merchants). The recommendation engine 302 may identify opportunities based on results received through a marketing channel, marketing platform, ad platform, and the like, such as marketing channels or external platforms that offer ad products for merchants to reach customers (e.g., Facebook, Instagram, Google, Bing, Twitter, LinkedIn, Pinterest, social networks, search engines, email marketing, and the like). In embodiments, historical marketing data may be used as a function of the type of channel used, where data may be aggregated from other merchants, such as from different stages of enterprise and/or product development/marketing.

In embodiments, the recommendation engine 302 may identify opportunities to the merchant that target increasing product commercialization, such as improving products that could sell better (e.g., recommendations for improving the presentation of products, improving the description of products, or improving the product itself (e.g., through comparisons of the product with similar products that have greater sales)), making adjustments for products frequently ‘abandoned’ (e.g., a product placed into a sales cart but not purchased), making suggestions for products that have high potential (e.g., based on similar successful products), helping to improve products that are trending up (e.g., marketing to increase visibility of the product), improving the sales of top-selling products (e.g., marketing to an established audience that has not yet purchased the top-selling product), and the like.

In embodiments, the recommendation engine 302 may identify opportunities based on a combination of data, such as customers viewing data (viewing a product vs. not viewing) in combination with sales data (product sale vs. no sale). In an example, combinations of these two data signals result in four categories: (1) a product being viewed and has sales, (2) a product being viewed and has no sales, (3) a product having no views but still has sales, and (4) a product with no views and no sales. For instance, if a product is being viewed but has no sales, customers may be drawn to the product but then don't make the purchase. The recommendation engine 302 may then make a recommendation based on additional data, such as based on comparable prices of similar products, based on an assessment of the product description, and the like, in order to help the merchant turn an attractive product (one that produces views from customers) into a product that sells. In another instance, if a product has no views and no sales, the recommendation engine 302 may make recommendations related to marketing the idea of the product through social media (e.g., Facebook), then watching to see if sales increase, and then recommending a more product-focused marketing effort (e.g., through Google). Recommendations targeting combinations of different data signals may enable the recommendation engine 302 to focus the merchant on needs for the store, a product line, a specific product, and the like, such as whether to focus on social media ads verses search engine ads, retargeting existing audiences or bringing in in new customers, and the like. Recommendations may enable the creation of custom marketing for different product groups, customer groups, and the like, such as with a statistical model(s) based on data 134 related to merchants, customers, products, and the like. In embodiments, the recommendation engine 302 may identify opportunities for marketing campaigns related to segmenting or categorizing types of marketing campaigns, such as social media based campaigns (e.g., through Facebook) versus search engine product based campaigns (e.g., through Google). For example, a campaign may be identified based on a different combination of data, such as targeting product based campaigns when a product is successful (e.g., views and sales) but targeting social media based campaigns when a product is not successful (e.g., no views and no sales).

In embodiments, once an opportunity is identified, the opportunity may be optimized 306 based on a merchant characteristic, historical cross-platform data, detected trends, and the like. Opportunities may be based on a goal for the merchant, such as based on predicting the probability of achieving a goal (e.g., based on historical data for similar stores), retargeting an opportunity for a budget goal, for a particular business development stage 402, and the like. A merchant may set a budget model to which opportunities may be optimized, such as establishing a marketing goal for the merchant (e.g., achieving a steady flow of visitors (traffic), and then using Facebook to find a look-a-like audience), establishing a budget model related to how much the merchant should spend, and the like. Budget model optimizations may be customized to different business development stages, such as where the business development stages are optimized for when a merchant is still finding an audience for an online store (e.g. a budget optimization for a first stage of development) versus when a merchant starts making sales (e.g., a budget optimization for a second stage of development), when a merchant has no traffic yet (e.g., a budget optimization for an alternate first stage of development) versus when a merchant has traffic but still has no sales yet (e.g., a budget optimization for an alternate second stage of development), and the like. An opportunity may be optimized based on merchant characteristics/parameters, such as based on product characteristics, time-based event parameters, audience-based parameters, past gross merchandise volume (GMV), customer feedback characteristics, and the like. An opportunity may be optimized based on a marketing channel, such as based on product-based marketing (e.g., Google), audience-based marketing (e.g., Facebook), and the like. For instance, an opportunity may be optimized to utilize a product-based marketing channel to gain an initial product goal, and then use an audience-based marketing channel to re-engage an audience. In embodiments, optimization may factor in differences between the effectiveness of different marketing channels, such as based on a marketing effectiveness normalization factor. For instance, a multiplier may be established for different channels, such as based on different conversion rates for the channels (e.g., normalizing clicks per sales for a search engine such as Google vs. visits per new audience member for a social network such as Facebook), based on historical data, and the like.

In embodiments, an opportunity may be optimized based on transactional data from merchants across the e-commerce platform with respect to a relative store comparison, such as to evaluate successful stores and see the opportunities that those stores exploited and compare to the merchant's store, evaluate the life span and success profile of other stores relative to this merchant's development stage, and the like. Optimization may be based on consumer trends, such as trending popular categories, evaluating what key trends affect a store's success, and the like. Optimization may be based on ROI for a specified dollar amount of investment based on a particular ad strategy, a top-selling product type opportunity (e.g., with respect to a marketing channel, ad type, or budget), products the merchant will sell (e.g., through a ranking), on sales prediction data (e.g., based on predicted visits and orders with respect to investment on ads for a given product), and the like. Optimization may be based on conversion rate data, such as based on a conversion action parameter data (e.g., data collected through a marketing event API (e.g., based on an ad format/action type)), marketing attribution data (e.g., cost of goods sold vs. marketing costs), conversion vs. marketing channel, ROI per channel, and the like. In embodiments, optimization may be based on opportunities related to customer lifecycles, such as opportunities for new customers, connecting with existing customers, keeping in touch with customers that are part of loyalty programs, connecting with customers that have not visited the merchant's online store and/or not purchased a product or service for a period of time, and the like. In embodiments, an optimization may target opportunities for connecting or reconnecting with customers, such as through email, loyalty programs, subscriptions, discount offers, and the like.

In embodiments, generating a recommendation 308 may be based on an opportunity that has been optimized, such as where a marketing recommendation consists of merchant action parameters (e.g., the product, marketing channel, and budget) that should be presented to the merchant, and including recommendations on how to distribute funds across ad activities. In embodiments, the e-commerce platform 100 may have access to a plurality of marketing related facilities and be agnostic to the products, marketing channels, and the like, that form the content of the recommendation, such as being agnostic to the channel that is selected for advertising (e.g., the decision for what channel to advertise based on a merchant need rather than channel affiliations). A recommendation may include a suggested product, marketing channel (e.g., including specific ad format or email newsletter type), budget, start time, and the like, with the proposal that this recommendation is most likely to convert a sale for that merchant, produced the highest return on marketing spend, and the like. Recommendations may include a suggestion for marketing campaigns, and direct the merchant to campaign recourses, such as for creating a campaign, creating a product or collection launch, an end of season campaign sale, a holiday campaign sale, and the like, such as localized to different parts of the world. For example, the recommendation may point the merchant to a sequence for establishing a particular marketing campaign activity, assist in selecting products, assist in launching the campaign, and the like. In embodiments, recommendations may be made at different hierarchical levels, such as at a campaign strategy level (e.g., overall goal of the campaign, such as to move existing inventory at the end of the season), at a product group level (e.g., moving certain seasonal products that take up too much warehouse space), at a specific product brand level (e.g., a set of tasks to market a certain brand), at an individual product level (e.g., a specific task for increasing the visibility of a potential subscription product through social media), and the like. Marketing recommendations may be the result of evaluating transactional data from the data facility 134 for opportunity identification 304 and optimization 306, such as based on a merchants' business development phase, current product inventory, marketing goals, budgetary goals, and the like. In embodiments, data from the data facility 134 may indicate a current business initiative of the merchant (e.g., adding new products or a product line, communicating with existing customers, initiating paid advertisements, and the like) where the recommendation engine 302 may make recommendations to support that initiative. For instance, a merchant may have set up a price rule associated with a buy-one-get-one free offer, and once a related product satisfies that price rule the recommendation engine 302 may trigger a campaign based on that rule and product (or product category).

In a non-limiting embodiment, the recommendation engine 302 may identify a subset of a plurality of online stores that have transitioned from a first merchant development phase to a second merchant development phase and identify a first online store currently in the first merchant development phase. The recommendation engine 302 may determine a plurality of merchant actions taken in association with the subset of the plurality of online stores while in the first merchant development phase and identify a marketing opportunity 304 for the first online store based on the plurality of merchant actions taken by the subset of the plurality of online stores. The recommendation engine 302 may deliver the identified opportunity 304 to a merchant client device 102. The recommendation engine 302 may optimize the opportunity 306 by evaluating the plurality of merchant actions to determine at least one merchant action with a positive return on investment value and generate at least one merchant recommendation 308 for the first online store associated with the determined merchant action. The recommendation engine 302 may deliver 310 the recommendation to a merchant client device 102 of the first online store. In embodiments, the second merchant development phase may be determined to have a greater commerce success measure than the first merchant development phase, characterized by a statistically significant growth in customers over the first merchant development phase, and the like. The first merchant development phase may be associated with an online store without customers, and the second merchant development phase may be associated with an online store with customers.

In embodiments, once a recommendation has been generated, the recommendation engine 302 may determine a method of recommendation delivery 310, such as for sending the best recommendation to the right online store, through the right channel, and at the ideal time. In embodiments, the e-commerce platform 100 may be agnostic to a recommendation delivery method, such as to the selection of a channel that is selected for delivery of a recommendation. The functional process for determining a method of recommendation delivery 310 may include retrieving recommendations from a previous phase, prioritizing and queueing recommendations that pertain to the online store, deciding the optimal delivery channel (e.g., through the administrator page, email, text, automated assistant, or commerce agent (e.g., human agent or software agent)), deciding on the time for delivery, validating that the online store and products still qualify for the recommendation, and the like, and then generating the content to send. The recommendation engine 302 may also consider whether customers have agreed to or opted out of communications or certain modes of communication (e.g., opted out of emails), and alter recommendations and recommendation deliveries related to customer communications accordingly (e.g., modifying email blast lists based on customer preferences). Recommendations may be delivered through a recommendation API, such as including a service to allow pulling the best recommendations for a given online store (e.g., an API on the merchant device that pulls recommendations from the recommendation engine). Recommendations may be delivered through a recommendation push client, such as including a service that pushes through (e.g., HTTP POST) the best recommendations for a given shop (e.g., recommendations are pushed from the recommendation engine to the merchant device). In embodiments, the recommendation engine 302 may maintain a queue of multiple ranked marketing opportunities at any given time.

In embodiments, the recommendation engine 302 may provide for merchant action tracking, such as including internal tracking of recommendation acceptance, internal tracking of merchant's marketing activity, benchmarking, and the like. Benchmarking may provide the recommendation engine 302 with metrics relating to a merchant's self-marketing by tracking the merchant's self-marketing and then benchmarking against that result with respect to the effectiveness of the recommendation engine 302 performing similar tasks, such as based on collected cross-platform data. For example, through benchmarking, it may be shown that for a particular re-targeting case that the recommendation engine performs 1.4× better than a merchant dproviding marketing activities on their own). In embodiments, recommendation delivery (e.g., at the recommendation engine side) may collect feedback from merchants, and/or the merchant device client may send feedback to the recommendation engine's recommendation delivery facility.

In embodiments, the recommendation engine 302 may utilize a model to implement at least portions of the opportunity-optimization-recommendation process, such as using machine learning (e.g., which may utilize non-linear models, such as random forest models, rather than a linear model. In embodiments, model inputs may include merchant parameters such as merchant constraints, product characteristics, time-based event parameters, audience-based parameters, gross merchandise volume (GMV), customer feedback characteristics, stage of business development for the merchant, and the like. Merchant constraints may include objectives (e.g., timing, products, or volume), budget and/or cash-flow constraints (e.g., cost per year, cost per week, or peak cost per period), product volume constraints (e.g., shipping, warehousing, supplier, manufacturing volume, or web site-server volume), channel access (mail, e-mail, social media, signage, radio, or television), and the like. Product characteristics may include product type characteristics (e.g., clothing; electronics; beauty; household; automotive; or service provider, duration or location), product/service price characteristic (e.g., average price across product or service offerings, price range of offerings (e.g., lowest priced product/service or highest priced product/service)), and the like. Time-based event parameters may include time since first product/service offering, time of first sale/service, time of Nth sale/service (e.g., 2nd sale, 10th sale, 100th sale, or 1000th sale). Audience-based parameters may include an audience parameter measured by number of visits to a physical store or online store, number of positive social media indicators, and the like, or may include a size of an audience at first product offering, size of audience at first sale, size of audience at Nth sale, size of audience at one year, or number of visitors in last 30 days. GMV may be for the first month, quarter, year, second year, last 30 days, and the like. Customer feedback characteristics may include a feedback/sales ratio, positive/negative ratio, negative feedback/negative feedback resolution ratio, use of natural language processing to identify the intent of conversations, and the like. Stage of business development for a merchant may include an initial offering stage (e.g., marketing ideas for products but prior to first product sale, a first sales stage (e.g., sales have been made but volume is still low), a product success stage (e.g., sales volume is established), and the like.

In embodiments, model training may include data associated with marketing and transactional data from merchants across the e-commerce platform, characteristics of available marketing channels, marketing campaign data, ad effectiveness (e.g., per ad type), urchin tracking module (UTM) parameters tracking data, and the like.

In embodiments, model outputs may include opportunity identification 304, optimization of opportunities 306, recommendations 308, recommendation delivery 310, and the like, where each may be a model output for use or may be used as an input to a next model layer. For instance, identified opportunities 304 may be provided as an input to the optimization of opportunities 308 model layer, or used as an output for further processing or use. In an example, identified opportunities 304 may be sent to a merchant for consideration.

In embodiments, example opportunity model outputs may include an indication that it is time for the merchant to expand product offerings, time for an ad campaign, time to retarget an audience, time to target a new audience, opportunity for a new audience demographic or look-a-like audience as compared to an existing audience, and the like. In embodiments, example optimization model outputs may include a product emphasis characteristic (e.g., ads for ‘A’ product best in connection with a search engine such as Google, ads for ‘B’ product audience best on a social network such as Facebook), a spend profile characteristic such as a cost per marketing vehicle (e.g., spend x % on a search engine such as Google ads and y % on social media such as Facebook ads) or cost per time (e.g., spend over upcoming period, such as week, month, quarter; or spend during the holidays vs. leading up to the holidays vs. after the holidays), a channel emphasis characteristic such as for ad distribution across channels (e.g., % of ads for ‘A’ on a search engine such as Google and % of ads for ‘A’ on a social network such as Facebook), and the like.

In embodiments, recommendation examples generated by the recommendation engine 302 may relate to a recommended mixture of ads and funds, types of ads, audience targeting and retargeting, new ad campaigns, and the like. For example, the recommendation engine 302 may recommend a mixture of funds to spend on a number of marketing channels (e.g., spend a specified dollar amount on a social network such as Facebook for advertising product ‘A’ to a new audience and another specified dollar amount on a search engine such as Google for advertising product ‘B’ to an existing audience; or split the cost being spent with a specified dollar amount to a social network for products A, B, and C, and another specified dollar amount to a search engine for products D and E), recommend types of ads to use (e.g., theme based, ads with pictures vs. not, multiple products vs. single product focus, or broadcast to existing audience or re-target), recommend how a mixture of funds should change over time (e.g., migrate advertising of product ‘A’ from a social network to a search engine once an audience is established (e.g., creating an audience on social network for a teenage product for obsessive compulsive disorder, and then migrating to selling the product on a search engine once the product becomes well known)), recommend spending funds in the next quarter on new audience development, recommend spending on product advertising for a holiday period, recommend adding a business-related capacity (e.g., inventory, staffing, or shipping) for product ‘C’ for a holiday period, and the like. The recommendation engine 302 may recommend a retargeting strategy, such as to increase conversion (e.g., such as sending the merchant the message “you managed to get a few hundred visitors to your store, but only 1-2% bought something—the fact that so many people interested in the store is very good, but they didn't buy anything, so you may want to re-target them”, or “we noticed a lot of visitors came and we think you are ripe for a re-targeting campaign”), to recapture an audience (e.g., “you've had some churn, send an email to your customers to get the churn audience back”), and the like. The recommendation engine 302 may recommend creating a new audience, such as at an early market development stage (e.g., “you have no visitors yet, so you don't need any re-targetin—instead, create an ad on the platform to drive traffic”). The recommendation engine 302 may recommend a new ad campaign such as an email campaign (e.g., where email is inexpensive, so ROI will be positive), recommend targeting a trend (e.g., “we noticed artwork sales are trending across the e-commerce platform, so we recommend you spend a specified dollar amount on ads”), and the like. Note that the recommendation engine 302 may have model inputs for a merchant's products, inventory, sales, and the like, and as such may be able to determine that not sending certain recommendations is appropriate (e.g., when a recommendation doesn't currently fit with a merchant's status or the store's life cycle). For instance, the recommendation engine 302 may not send a message related to increasing advertising on a product the merchant is already selling out of. In embodiments, once recommendations are created and queued up, the recommendation engine 302 may determine the best way for delivering the recommendation (e.g., the best time and/or the best channel). The recommendation engine 302 may provide the recommendation(s) to merchants through a variety of communication channels, a merchant home page, a commerce agent (e.g., software or human), a merchant marketing recommendation user interface, and the like.

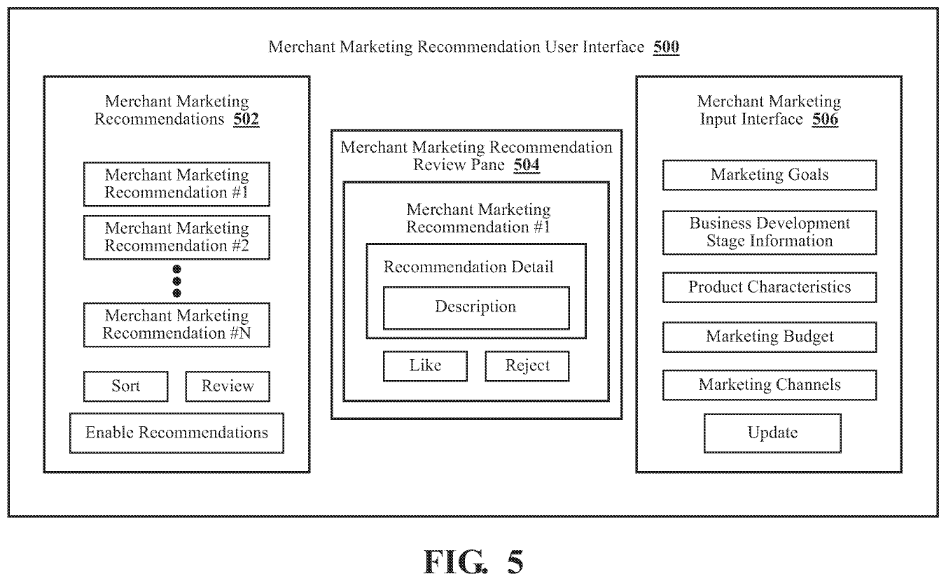

FIG. 5 depicts a non-limiting example for a merchant marketing recommendation user interface 500, including a window for displaying merchant marketing recommendations 502 (e.g., showing delivered recommendations), a window for displaying a merchant marketing recommendations review pane 504 (e.g., providing detail for a selected recommendation), and a window for displaying a merchant marketing input interface 506 (e.g., such as including buttons for viewing data associated with marketing goals, business development stage information, product characteristics, marketing budget, and marketing channels).

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g. Long Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

What is claimed is:

1. A computer-implemented method comprising:
retrieving, by a processor-based recommendation engine, merchant commerce data from a data facility, wherein the merchant commerce data is associated with a plurality of online stores and comprising a plurality of merchant actions;
identifying a first online store currently in a first merchant development phase;
identifying a merchant opportunity for the first online store based on the plurality of merchant actions to determine at least one merchant action with a positive return on investment value;
generating at least one merchant recommendation for the first online store associated with the determined at least one merchant action; and
communicating the at least one merchant recommendation to a client device of the first online store.

2. The computer-implemented method of claim 1, wherein the identifying the merchant opportunity is executed by the processor-based recommendation engine utilizing a model generated using machine learning.

3. The computer-implemented method of claim 1, further comprising identifying a subset of the plurality of online stores that have transitioned from the first merchant development phase to a second merchant development phase, wherein the second merchant development phase is determined to have a greater commerce success measure than the first merchant development phase.

4. The computer-implemented method of claim 1, further comprising identifying a subset of the plurality of online stores that have transitioned from the first merchant development phase to a second merchant development phase, wherein first merchant development phase is associated with an online store without customers, and the second merchant development phase is associated with an online store with customers.

5. The computer-implemented method of claim 1, further comprising identifying a subset of the plurality of online stores that have transitioned from the first merchant development phase to a second merchant development phase, wherein second merchant development phase is characterized by a statistically significant growth in customers over the first merchant development phase.

6. The computer-implemented method of claim 1, wherein the at least one merchant recommendation is communicated through a home page of the first online store.

7. The computer-implemented method of claim 1, wherein the at least one merchant recommendation is communicated through a commerce agent to the first online store.

8. The computer-implemented method of claim 1, wherein the at least one merchant recommendation is communicated through an email to a merchant of the first online store.

9. A computer-implemented method comprising:
retrieving, by a processor-based recommendation engine, merchant commerce data from a data facility, wherein the merchant commerce data is associated with a plurality of online stores and comprises merchant marketing activity data;
identifying a subset of the plurality of online stores that have transitioned from a first merchant development phase to a second merchant development phase;
identifying a first online store currently in the first merchant development phase;
determining, by the processor-based recommendation engine and utilizing a model generated using machine learning, a plurality of merchant actions taken by the subset of the plurality of online stores while in the first merchant development phase, wherein the plurality of merchant actions is determined from evaluation of the merchant marketing activity data;
identifying a merchant opportunity for the first online store based on the plurality of merchant actions; and
communicating the merchant opportunity to a client device of the first online store.

10. The computer-implemented method of claim 9, wherein the second merchant development phase is determined to have a greater commerce success measure than the first merchant development phase.

11. The computer-implemented method of claim 9, wherein the first merchant development phase is associated with an online store without customers, and the second merchant development phase is associated with an online store with customers.

12. The computer-implemented method of claim 9, wherein the second merchant development phase is characterized by a statistically significant growth in customers over the first merchant development phase.

13. The computer-implemented method of claim 9, wherein the merchant opportunity is communicated through a home page of the first online store.

14. The computer-implemented method of claim 9, wherein the merchant opportunity is communicated through a commerce agent to the first online store.

15. The computer-implemented method of claim 9, wherein the merchant opportunity is communicated through an email to a merchant of the first online store.

16. A system comprising:
a processor-based recommendation engine configured to store a set of instructions that, when executed, cause the processor-based recommendation engine to:
retrieve merchant commerce data from a data facility, wherein the merchant commerce data is associated with a plurality of online stores and comprising a plurality of merchant actions;
identify a first online store currently in a first merchant development phase;
identify a merchant opportunity for the first online store based on the plurality of merchant actions to determine at least one merchant action with a positive return on investment value;
generate at least one merchant recommendation for the first online store associated with the determined at least one merchant action; and
communicate the at least one merchant recommendation to a client device of the first online store.

17. The system of claim 16, wherein the identifying the merchant opportunity is executed by the processor-based recommendation engine utilizing a model generated using machine learning.

18. The system of claim 16, further comprising identifying a subset of the plurality of online stores that have transitioned from the first merchant development phase to a second merchant development phase, wherein the second merchant development phase is determined to have a greater commerce success measure than the first merchant development phase.

19. The system of claim 16, further comprising identifying a subset of the plurality of online stores that have transitioned from the first merchant development phase to a second merchant development phase, wherein first merchant development phase is associated with an online store without customers, and the second merchant development phase is associated with an online store with customers.

20. The system of claim 16, further comprising identifying a subset of the plurality of online stores that have transitioned from the first merchant development phase to a second merchant development phase, wherein second merchant development phase is characterized by a statistically significant growth in customers over the first merchant development phase.

21. The system of claim 16, wherein the at least one merchant recommendation is communicated through a home page of the first online store.

22. The system of claim 16, wherein the at least one merchant recommendation is communicated through a commerce agent to the first online store.

23. The system of claim 16, wherein the at least one merchant recommendation is communicated through an email to a merchant of the first online store.

24. A system comprising:
a processor-based recommendation engine configured to store a set of instructions that, when executed, cause the processor-based recommendation engine to:
retrieve merchant commerce data from a data facility, wherein the merchant commerce data is associated with a plurality of online stores and comprises merchant marketing activity data;
identify a subset of the plurality of online stores that have transitioned from a first merchant development phase to a second merchant development phase;
identify a first online store currently in the first merchant development phase;
determine, by the processor-based recommendation engine and utilizing a model generated using machine learning, a plurality of merchant actions taken by the subset of the plurality of online stores while in the first merchant development phase, wherein the plurality of merchant actions is determined from evaluation of the merchant marketing activity data;
identify a merchant opportunity for the first online store based on the plurality of merchant actions; and
communicate the merchant opportunity to a client device of the first online store.

25. The system of claim 24, wherein the second merchant development phase is determined to have a greater commerce success measure than the first merchant development phase.

26. The system of claim 24, wherein the first merchant development phase is associated with an online store without customers, and the second merchant development phase is associated with an online store with customers.

27. The system of claim 24, wherein the second merchant development phase is characterized by a statistically significant growth in customers over the first merchant development phase.

28. The system of claim 24, wherein the merchant opportunity is communicated through a home page of the first online store.

29. The system of claim 24, wherein the merchant opportunity is communicated through a commerce agent to the first online store.

30. The system of claim 24, wherein the merchant opportunity is communicated through an email to a merchant of the first online store.
